(19) United States
(12) Patent Application Publication
(10) Pub. No.: US 2009/0092889 A1
(43) Pub. Date: Apr. 9, 2009

(54) LITHIUM SECONDARY BATTERY

(75) Inventors: Cheolhee Hwang, Yongin-si (KR); Wanmook Lim, suwon-si (KR); Hyorim Bak, Yongin-si (KR); Myungro Lee, Yongin-si (KR); Youngchurl Chang, Yongin-si (KR)

Correspondence Address: KNOBBE MARTENS OLSON & BEAR LLP, 2040 MAIN STREET, FOURTEENTH FLOOR, IRVINE, CA, 92614, US

(73) Assignee: Samsung SDI Co., Ltd., Suwon-si (KR)

(21) Appl. No.: 12/247,456

(22) Filed: Oct. 8, 2008

(30) Foreign Application Priority Data
Oct. 9, 2007 (KR) 10-2007-0101657

(51) Int. Cl. H01M 6/10

(52) U.S. Cl. 429/94

(57) ABSTRACT

Provided is a lithium secondary battery which is stable to penetration of a sharp object, which may occur by external impact. The lithium secondary battery comprises an electrode assembly which is formed by winding a first electrode plate, a second electrode plate, and a separator disposed between the first electrode plate and the second electrode plate; and a can for receiving the electrode assembly, wherein the separator is formed of a ceramic material, a polarity of the first electrode plate is opposite to that of the can, and the outermost part of the first electrode plate is disposed further outside than the outermost part of the second electrode plate.

### CROSS REFERENCE TO RELATED APPLICATION

This application is based on and claims priority to Korean Patent Application No. 10-2007-0101657, filed on Oct. 9, 2007, in the Korean Intellectual Property Office (KIPO), the entire contents of which are hereby incorporated by reference.

### BACKGROUND OF THE INVENTION

1. Technical Field

The present disclosure relates to a lithium secondary battery. More specifically, the present invention relates to a lithium secondary battery that remains stable even upon penetration of a sharp object into the battery.

2. Description of the Related Art

Generally, a secondary battery is rechargeable and can be miniaturized, while exhibiting a large capacity. In recent years, increasing demands for portable electronic equipment, such as camcorders, portable computers, and mobile phones, have led to active research and development of secondary batteries as an energy source for the portable electronic equipment. Among these secondary batteries, a great deal of attention has focused on nickel-metal hydride (Ni-MH) batteries, lithium ion (Li-ion) batteries, and lithium ion polymer batteries.

Lithium, which is widely used as a material for a secondary battery, has a low atomic weight and is therefore suitable for fabrication of a battery having a high electrical storage capacity per unit mass. Further, as lithium reacts violently with water, a lithium-based battery usually employs a non-aqueous electrolyte. The lithium-base battery can advantageously generate an electromotive force of about 3 to 4 volts because it is not affected by a water electrolysis voltage.

Abuse and misuse of lithium secondary batteries have raised concerns associated with the stability of the battery. In particular, there are increasing cases in which internal short-circuiting takes place upon penetration of a sharp object into the lithium secondary battery due to an external impact, which causes accidental fires, which can result in injury or death. In order to cope with the current situation, many attempts and efforts have been made to improve the stability of the battery. However, it is currently difficult to ensure the stability of the battery due to frequent occurrence of ignition under severe conditions such as penetration of a sharp object such as a fine pin into the secondary battery.

### SUMMARY OF THE INVENTION

Therefore, in view of the above and other problems, it is an object to provide a lithium secondary battery that is capable of significantly increasing stability of the battery even when internal short-circuiting takes place due to penetration of a sharp object into the battery.

In accordance with one aspect, the above and other objects can be accomplished by the provision of a lithium secondary battery, comprising an electrode assembly which is formed by winding a first electrode plate, a second electrode plate, and a separator disposed between the first electrode plate and the second electrode plate, and a can for receiving the electrode assembly, wherein the separator is formed of a ceramic material, a polarity of the first electrode plate is opposite to that of the can, and the outermost part of the first electrode plate is disposed further outside than the outermost part of the second electrode plate.

Herein, the first electrode plate and the second electrode plate include an electrode current collector and an electrode active material layer, respectively, both ends of the first electrode plate and the second electrode plate are provided with a first electrode uncoated area and a second electrode uncoated area, and the first electrode uncoated area disposed in the outermost area of the first electrode plate may form at least 1 turn.

Further, the first electrode uncoated area may be made only of the electrode current collector, the separator may be disposed to surround the outermost part of the electrode assembly, and the separator may be adhered to a previous turn of the separator while surrounding the outermost part of the electrode assembly.

Further, the shortest distance from the outermost 1 turn of the first electrode uncoated area to the can may be formed to have substantially the same value along a circumference of the can, and the first electrode uncoated area meeting an imaginary line defining the shortest distance and a tangent plane at a point of the can may be parallel to each other.

Further, the separator may include a porous film which is formed of a ceramic material using a binder, and the ceramic material may be at least one of silica (SiO₂), alumina (Al₂O₃), zirconium oxide (ZrO₂), titanium oxide (TiO₂), and any combination thereof. Herein, the separator may be formed by coating the ceramic material on the first electrode plate or the second electrode plate.

Further, embodiments of the lithium secondary battery may further comprise a cap assembly which binds to an upper part of the can and then seals the can. The polarity of the first electrode plate may be formed to have a positive or negative polarity.

In accordance with another aspect, there is provided a lithium secondary battery, comprising an electrode assembly which is formed by winding a first electrode plate, a second electrode plate, and a separator disposed between the first electrode plate and the second electrode plate, a short-circuiting part, which is connected to the electrode assembly in the outermost area of the electrode assembly and surrounds the outermost area of the electrode assembly in at least one turn, and a can for receiving the electrode assembly and the short-circuiting part, wherein the separator is formed of a ceramic material, a polarity of the first electrode plate is opposite to that of the can, the outermost part of the first electrode plate is disposed further outside than the outermost part of the second electrode plate, and the short-circuiting part may include in an insulating portion connected to the outermost end of the separator and an electrode portion connected to the outermost end of the first electrode plate.

Herein, the first electrode plate includes an electrode current collector and an electrode active material layer, a central end of the first electrode plate is provided with an electrode uncoated area and the insulating portion may be disposed to surround the outermost part of the electrode assembly.

Further, the electrode portion may be made of a material that is identical with that of the electrode current collector, and the electrode portion may be formed to have a thickness thicker than the electrode current collector.

Further, the electrode portion may be made of the electrode current collector and a material having a high electrical conductivity, and the electrode portion may be formed to have a thickness thinner than the electrode current collector.

Further, the separator may include a porous film which is formed of a ceramic material using a binder, and the ceramic material may be at least one of silica (SiO₂), alumina (Al₂O₃), zirconium oxide (ZrO₂), titanium oxide (TiO₂), and any combination thereof.

Further, the separator may be formed by coating the ceramic material on the first electrode plate or the second electrode plate. Alternatively, the separator may be formed by coating the ceramic material on the electrode portion.

According to the above configuration, in some embodiments, the separator is fabricated to have a polarity different from that of the electrode plate faced opposite to the can and includes the ceramic material, so the separator is adapted to serve as a protective device upon penetration of sharp objects into the lithium secondary battery. As a result, it is possible to further enhance the stability of the lithium secondary battery by preventing the propagation of internal short-circuiting in conjunction with external dissipation of an electric current generated upon penetration of sharp objects into the lithium secondary battery.

Some embodiments provide a lithium secondary battery comprising an electrode assembly disposed in a can. The electrode assembly comprises a first electrode plate, a second electrode plate, and a separator disposed therebetween, and is wound together. The first electrode plate and/or a short-circuiting part coupled thereto comprises at least the outermost 1 turn of the wound-together electrode assembly. The separator comprises a ceramic material disposed on at least one of the first electrode plate and the second electrode plate. The first electrode plate and the can have opposite polarities. The resulting lithium secondary battery exhibits improved stability when penetrated by sharp objects, for example, reduced ignition rate.

Some embodiments provide a lithium secondary battery, comprising: an electrode assembly comprising a first electrode plate, a second electrode plate, and a separator disposed between the first electrode plate and the second electrode plate, wound together; and a can dimensioned and configured for receiving the electrode assembly. The separator comprises a ceramic material, a polarity of the first electrode plate is opposite to a polarity of the can, and an outermost portion of the first electrode plate is disposed farther outside the electrode assembly than an outermost part of the second electrode plate.

In some embodiments, the first electrode plate comprises an electrode current collector and an electrode active material layer, the second electrode plate comprises an electrode current collector and an electrode active material layer, an end of the first electrode plate comprises a first electrode uncoated area, an end of the second electrode plate comprises a second electrode uncoated area, and the first electrode uncoated area forms at least 1 turn disposed at the outermost portion of the first electrode plate. In some embodiments, the first electrode uncoated area comprises only the electrode current collector.

In some embodiments, a portion of the separator surrounds the outermost portion of the electrode assembly. In some embodiments, the portion of separator surrounding the outermost portion of the electrode assembly is adhered to a previous turn of the separator.

In some embodiments, a shortest distance from the outermost 1 turn of the first electrode uncoated area to the can has a substantially constant value around a circumference of the can. In some embodiments, a tangent plane to the first electrode uncoated area and a tangent plane at a point of the can, joined by an imaginary line defining the shortest distance therebetween, are substantially parallel to each other.

In some embodiments, the separator comprises a porous film comprising a ceramic material and a binder. In some embodiments, the ceramic material comprises at least one of silica (SiO₂), alumina (Al₂O₃), zirconium oxide (ZrO₂), titanium oxide (TiO₂), and any combination thereof. In some embodiments, the separator comprises the ceramic material disposed on at least one of the first electrode plate and the second electrode plate.

Some embodiments further comprise a cap assembly which engages an upper part of the can and seals the can.

In some embodiments, the polarity of the first electrode plate is positive. In some embodiments, the polarity of the first electrode plate is negative.

Some embodiments provide a lithium secondary battery, comprising: an electrode assembly comprising a first electrode plate, a second electrode plate, and a separator disposed between the first electrode plate and the second electrode plate, wound together; a short-circuiting part coupled to the electrode assembly in an outermost portion of the electrode assembly, and surrounding at least one turn of the outermost portion of the electrode assembly; and a can dimensioned and configured for receiving the electrode assembly and the short-circuiting part. The separator comprises a ceramic material, a polarity of the first electrode plate is opposite to a polarity of the can, an outermost portion of the first electrode plate is disposed farther outside the electrode assembly than an outermost portion of the second electrode plate, and the short-circuiting part comprises an insulating portion adjacent to and contacting the outermost end of the separator and an electrode portion coupled to the outermost end of the first electrode plate.

In some embodiments, the first electrode plate comprises an electrode current collector and an electrode active material layer, an end of the first electrode plate comprises an electrode uncoated area, and the insulating portion surrounds an outermost portion of the electrode assembly. In some embodiments, the electrode portion and the current collector of the first electrode plate comprise a same material. In some embodiments, the electrode portion is thicker than the current collector of the first electrode plate. In some embodiments, the electrode portion and the current collector of the first electrode plate comprise a same material having a high electrical conductivity. In some embodiments, the electrode portion is thinner than the current collector of the first electrode plate.

In some embodiments, the separator comprises a porous film comprising a ceramic material and a binder.

In some embodiments, the ceramic material comprises at least one of silica (SiO₂), alumina (Al₂O₃), zirconium oxide (ZrO₂), titanium oxide (TiO₂), and any combination thereof. In some embodiments, the separator comprises a ceramic material disposed on at least one of the first electrode plate or the second electrode plate. In some embodiments, at least a portion of the separator is disposed on the electrode portion.

### BRIEF DESCRIPTION OF THE DRAWINGS

The above and other objects, features, and other advantages will be more clearly understood from the following detailed description taken in conjunction with the accompanying drawings, in which:

FIG. 1 is a schematic exploded perspective view of an embodiment of a lithium secondary battery;

FIG. 2 is a schematic longitudinal cross-sectional view showing a can of FIG. 1 in which an electrode assembly is housed;

FIG. 3 is a schematic cross-sectional view showing an electrode assembly housed in a can of FIG. 1;

FIG. 4 is a schematic cross-sectional view showing another embodiment of an electrode assembly housed in a can;

FIG. 5 is an enlarged view of area V of FIG. 4;

FIG. 6 is a sectional view showing another embodiment of an electrode assembly housed in a can; and

FIG. 7 is a sectional view schematically showing a nail penetration test for a lithium secondary battery.

### DETAILED DESCRIPTION OF CERTAIN EMBODIMENTS

Now, certain embodiments will be described in more detail with reference to the accompanying drawings, which, as will be understood by those skilled in the art, to which various modifications, additions, and substitutions are possible without departing from their scope and spirit. Unless otherwise defined, all technical and scientific terms used herein have the same meaning as commonly understood by one of ordinary skill in the relevant art. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity. Like numbers refer to like elements throughout the specification and drawings. In the figures, the thickness of certain layers, regions and areas may be exaggerated for clarity.

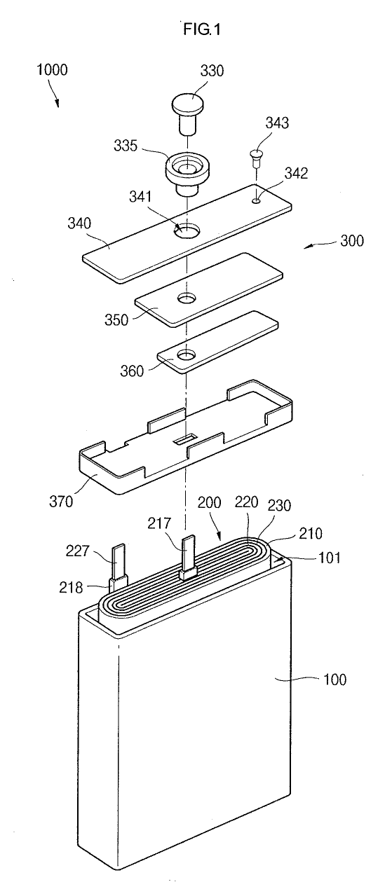

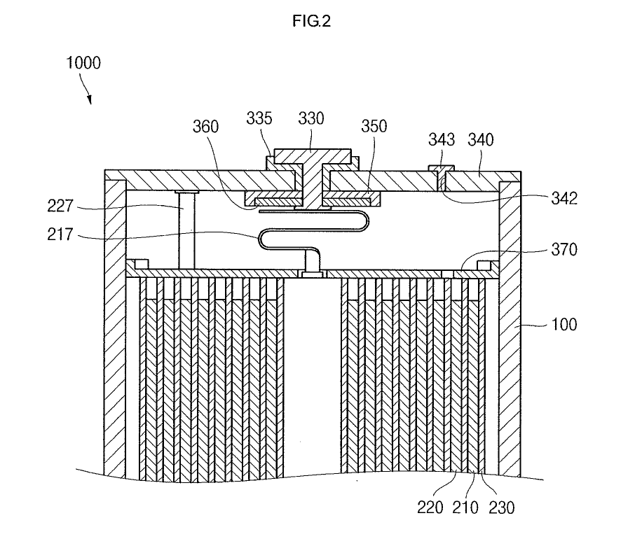

FIG. 1 is a schematic exploded perspective view of an embodiment of a lithium secondary battery, and FIG. 2 is a schematic longitudinal cross-sectional view showing a can 100 into which an electrode assembly is housed in FIG. 1. In this connection, even though a prismatic lithium secondary battery is shown in FIG. 1, the present invention is not limited to prismatic secondary batteries and may also be applied to cylindrical lithium secondary batteries or pouch type secondary batteries which also fall within the scope of the present invention.

Referring to FIGS. 1 and 2, an embodiment of a lithium secondary battery 1000 comprises a can 100 and an electrode assembly 200 housed in the can 100. Further, as shown in FIG. 1, the can-type secondary battery 1000 in accordance with the present embodiment may further comprise a cap assembly 300, which seals tightly an upper opening 101 of the can 100.

The can 100 may be formed of a generally rectangular-shaped metal material, which may also serve as an electrode terminal. However, the shape of the can 100 is not limited thereto. A polarity of the can is opposite to that of a first electrode plate 210, as will be illustrated hereinafter. Further, although not shown in FIG. 2, the can 100 may be equipped with a heat radiation area-extension portion with a shape that provides an enlarged heat radiation area, such that heat generated inside the can 100 can be further radiated to the outside. The can 100 includes an upper opening 101 formed on one side thereof, and the electrode assembly 200 is received through the upper opening 101.

Referring to FIG. 2, the can 100 is disposed proximally or adjacent to a first electrode plate 210 of the electrode assembly 200, as will be illustrated hereinafter. That is, the outermost part of the first electrode plate 210 is positioned closer to the can 100 than a second electrode plate 220 is to the can 100.

The electrode assembly 200 includes the first electrode plate 210, the second electrode plate 220, and a separator 230. The separator 230 is interposed between the first electrode plate 210 and the second electrode plate 220, and the resulting structure is wound in the form of a jelly roll.

The separator 230 comprises a porous material that serves to block electron conduction between the first electrode plate 210 and the second electrode plate 220 that might otherwise occur in the electrode assembly 200, and is capable of achieving smooth migration of lithium ions. For example, the separator 230 may comprise polyethylene (PE), polypropylene (PP), and/or a composite material film thereof, or otherwise may comprise a ceramic material. In an embodiment of the lithium secondary battery, the separator 230 may comprise a ceramic separator coated on the first electrode plate 210. Details of the ceramic separator will be illustrated hereinafter.

The first electrode plate 210 may be either a positive electrode plate or a negative electrode plate. In the illustrated embodiment of the lithium secondary battery, the polarity of the first electrode plate 210 is opposite to the polarity of the can 100. Therefore, when the polarity of the can 100 is positive, the polarity of the first electrode plate 210 is negative, or vice versa. Furthermore, the polarity of the second electrode plate 220 is to opposite to the polarity of the first electrode plate 210.

Further, an outermost part or portion of the first electrode plate 210 is disposed on an outside of the electrode assembly 200, thus being located farther outward than an outermost part or portion of the second electrode plate 220. Therefore, the battery is configured such that the can 100 preferentially short-circuits with the first electrode plate 210, when a sharp object penetrates the can 100.

On the other hand, a cap assembly 300 includes a cap plate 340, an insulating plate 350, a terminal plate 360, and an electrode terminal 330. The cap assembly 300 is insulated from the electrode assembly 200 by a separate insulating case 370 where it engages the upper opening 101 of the can 100, thereby sealing the can 100.

The cap plate 340 comprises a metal plate having a size and a shape corresponding to the upper opening 101 of the can 100. At about the center of the cap plate 340 is formed a terminal through-hole 341 having a given size through which the electrode terminal 330 is inserted. A tubular gasket 335 that insulates the electrode terminal 330 from the cap plate 340 is disposed between the terminal through-hole 341 the outer surface of the electrode terminal 330. One side of the cap plate 340 is provided with an electrolyte inlet 342 having a given size, and the other side of the cap plate 340 may be provided with a safety vent (not shown). The safety vent is integrally formed with the cap plate 340 by making a thinner portion of the cap plate 340. After assembling the cap assembly 300 to the upper opening 101 of the can 100, an electrolyte is injected via the electrolyte inlet 342, which is then closed with a stopper 343.

The electrode terminal 330 is coupled and/or connected to a first electrode tap 217 of the first electrode plate 210 or a second electrode tap 227 of the second electrode plate 220, thereby serving as a first electrode terminal or a second electrode terminal. In order to prevent short-circuiting, insulating tapes 218 are wound on portions of the first electrode tap 217 and the second electrode tap 227 extending from the electrode assembly 200.

Meanwhile, the remaining configuration of the lithium secondary battery is of any suitable design known in the art, and a description thereof is omitted hereinafter.

Hereinafter, an embodiment of a lithium secondary battery is described in more detail.

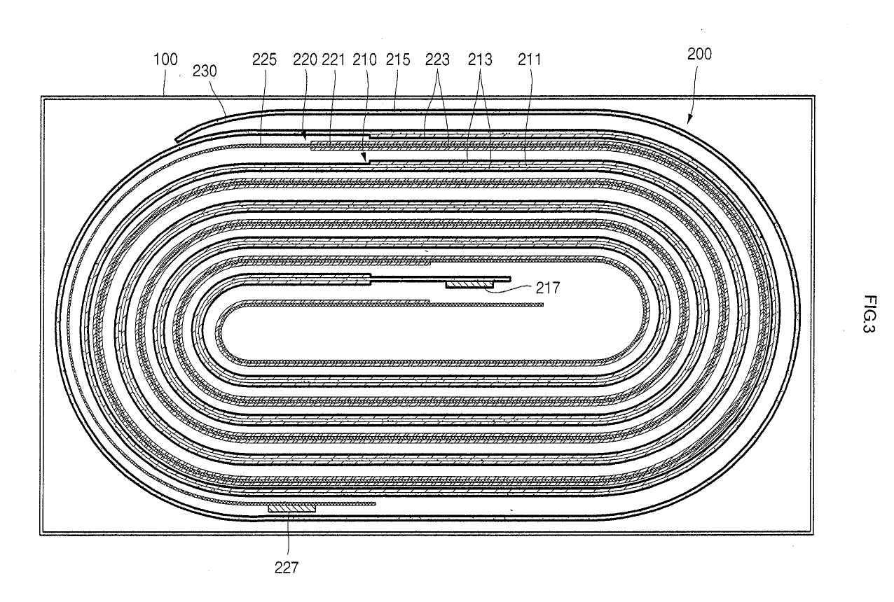

FIG. 3 is a schematic cross-sectional view of the battery illustrated in FIG. 1, showing the electrode assembly 200 housed in the can 100.

Referring to FIG. 3, as discussed above, in embodiments in which a polarity of the first electrode plate 210 is negative, the first electrode plate 210 includes a first electrode current collector 211 comprising thin copper foil, and a first electrode active material layer 213, comprising a carbon material as a main ingredient, coated on both sides of the first electrode current collector 211. In the first electrode current collector 211, both ends of the first electrode plate 210 comprise first electrode uncoated areas 215 in which the first electrode active material layer 213 is not coated on one or both sides of the first electrode current collector 211. The first electrode uncoated area 215 is coupled with a first electrode tap 217.

In embodiments in which the first electrode plate 210 is a negative electrode, the second electrode plate 220 is a positive electrode. Here, the second electrode plate 220 includes a second electrode current collector 221 comprising thin aluminum foil and a second electrode active material layer 223 comprising a lithium-based oxide as a main ingredient coated on both sides of the second electrode current collector 221. In the second electrode current collector 221, both ends of the second electrode plate 220 comprise second electrode uncoated areas 225 in which the second electrode active material layer 223 is not coated on one or both sides of the second electrode current collector 221. The second electrode uncoated area 225 is coupled with a second electrode tap 227.

The ceramic separator 230 comprises a ceramic separator disposed and/or coated on the first electrode plate 210 for insulation between the first and second electrode plates 210, 220. In this connection, as discussed above, the separator in the lithium secondary battery in accordance with the illustrated embodiment includes a porous film comprising a ceramic material and a binder. The ceramic separator 230 may be formed by coating the porous film on the electrode plate.

The ceramic material comprises at least one of silica (SiO₂), alumina (Al₂O₃), zirconium oxide (ZrO₂), titanium oxide (TiO₂) and any combination thereof. The binder may comprise an acrylic rubber having a three-dimensional crosslinked structure.

For formation of the separator, the ceramic material and the acrylic rubber binder having a crosslinked structure are mixed in a solvent to thereby prepare a paste, and the resulting paste is then coated on at least one of the electrode plates 210, 220 to form a ceramic separator 230. Although coating and forming of the ceramic separator 230 on the first electrode plate 210 is shown in FIG. 3, the lithium secondary battery is not limited to such a configuration.

That is, the ceramic separator 230 may be coated and formed on either or both of the first electrode plate 210 and the second electrode plate 220, because it is sufficient that the ceramic separator 230 prevents an internal short-circuiting between the first electrode plate 210 and the second electrode plate 220. Further, the ceramic separator 230 may be coated and formed on either or both sides of the first electrode plate 210 and/or the second electrode plate 220. Coating may be carried out by dipping the electrode plate in a solution of the porous film.

The ceramic separator 230 plays a role of a typical film-like separator formed of polyethylene (PE), polypropylene (PP), or the like. The ceramic material has a decomposition temperature of more than about 1000° C. due to its intrinsic nature, and the acrylic rubber binder has a decomposition temperature of more than 250° C. due to its crosslinked structure, so it is possible to obtain a battery with a high thermal resistance.

On the other hand, in the lithium secondary battery in accordance with the illustrated embodiment, the outermost part of the first electrode plate 210 is disposed on the outside of the electrode assembly 200, thus being located farther out than the outermost part of the second electrode plate 220, and the first electrode plate 210 has an opposite polarity from the can 100. Accordingly, in order to prevent short-circuiting between the can 100 and the first electrode plate 210, the ceramic separator 230 is disposed to surround the outermost part of the electrode assembly 200.

Meanwhile, in the lithium secondary battery in accordance with an embodiment, the first electrode plate 210 located at the outermost part of the electrode assembly 200 comprises at least about 1 turn of the first electrode uncoated area 215. More preferably, the first electrode uncoated area 215 comprises only the electrode current collector 211 to thereby provide a complete outermost one turn. In this case, the first electrode uncoated area 215 does not include the first electrode active material layer 213 having a relatively high resistance, so an electric current flowing between the electrode plate and a penetrating object, such as a nail and/or pin, is more effectively dissipated towards the external can, upon penetration of a sharp object into the lithium secondary battery.

As described above, the lithium secondary battery in accordance with an embodiment features the ceramic separator 230 in conjunction with opposite polarities between the can 100 and the first electrode plate 210 located at the outermost part of the electrode assembly 200. As a result, when an external object penetrates into the battery by external impact, the ceramic separator reduces and/or prevents melting of the separator due to heat generation, which occurs upon the penetration of a sharp object into the lithium secondary battery, and which consequently, reduces and/or prevents the propagation of internal short-circuiting. When the can and the first electrode plate 210 are first short-circuited, the electric current concentrated at the penetrated portion of the battery is smoothly distributed into the can. As a result, the stability of the lithium secondary battery is dramatically enhanced.

Hereinafter, a lithium secondary battery in accordance with another embodiment will be described in more detail.

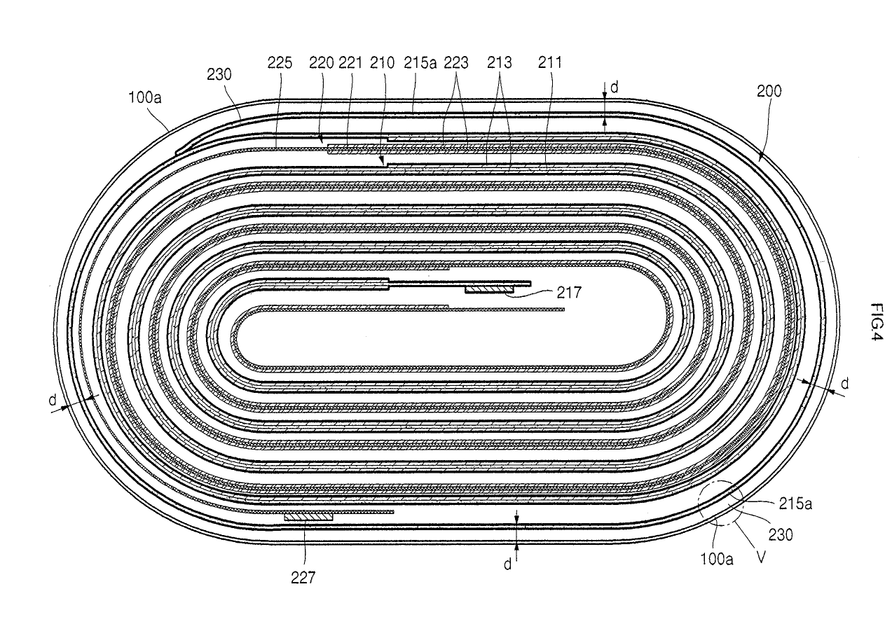

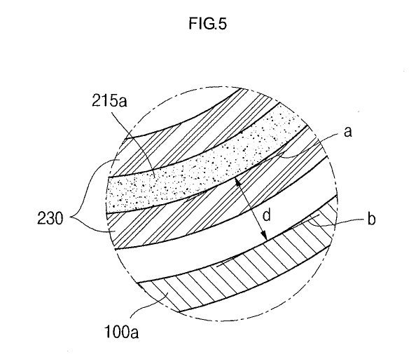

FIG. 4 is a schematic cross-sectional view showing an electrode assembly housed in a can 101a, in a lithium secondary battery in accordance with another embodiment, and FIG. 5 is an enlarged view of area V of FIG. 4.

In the present embodiment, like parts in previous embodiment (including related figures) are identified by like numbers. Herein, in the lithium secondary battery in accordance with the present embodiment, a can 100a and a ceramic separator 230a are different from the lithium secondary battery of the previous embodiment.

Referring to FIG. 4, corners of the can 100a in the lithium secondary battery in accordance with the illustrated embodiment are rounded. Further, the ceramic separator 230a surrounding the outermost part of the electrode assembly contacts the ceramic separator 230a of the previous turn of the electrode assembly. Accordingly, slippage of the electrode assembly 200 inside the can 100 is more efficiently inhibited.

Meanwhile, the can 100a is rounded, such that the shortest distance (d) from a point on an outer circumferential surface of the can 100a to the first electrode uncoated area 215a disposed at the outermost part of the first electrode plate 210 has substantially the same value. More specifically, referring to FIG. 5, the can 100a is configured such that a tangent plane a at a given point of the first electrode uncoated area, and a tangent plane b at a given point of an inner surface of the can are substantially parallel to each other when joined by an imaginary line defining the shortest distance between the first electrode uncoated area 215a and the can 100a.

That is, upon penetration of a sharp object into the lithium secondary battery, a depth of penetration of the object into the battery has substantially little or no significant deviation. As a result, the penetration depth of the object is more predictable. Consequently, the stability of the lithium secondary battery is further enhanced. Further, a rounded can results in an increase in the relative capacity of the electrode assembly and an improved flexibility in layout design.

Hereinafter, a lithium secondary battery in accordance with yet another embodiment will be described in more detail.

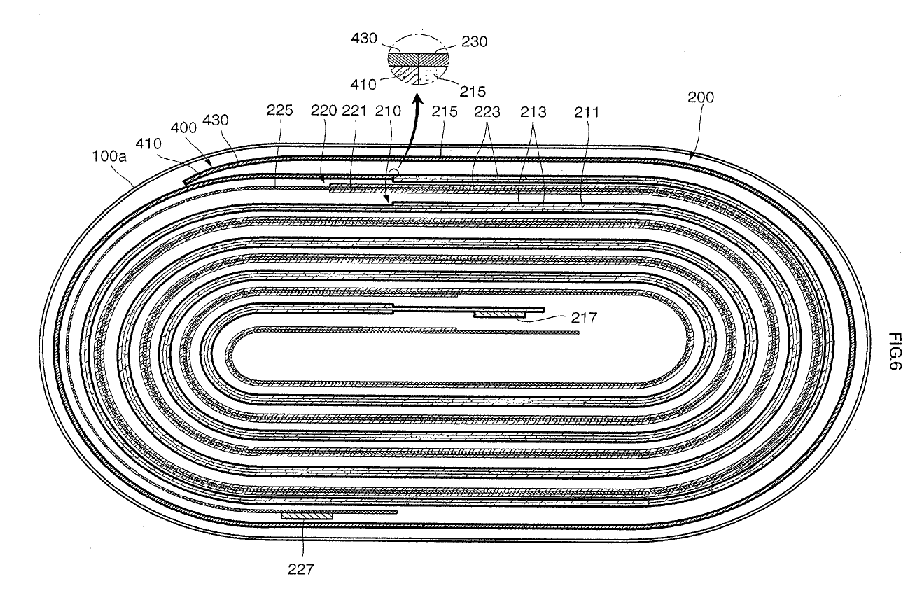

FIG. 6 is a cross-sectional view showing an electrode assembly housed in a can 100a, of a lithium secondary battery in accordance with yet another embodiment. In the present embodiment, like parts in previous embodiment (including related figures) are identified by like numbers. Herein, the lithium secondary battery in accordance with the present embodiment comprises a short-circuiting part 400.

The short-circuiting part 400 includes an electrode portion 410, which is coupled to an end of the first electrode current collector 211 positioned at the outermost area of the first electrode plate 210, and an insulating portion 430, which is adjacent to and contacts the separator 230 in a region opposite to the electrode current collector 211 positioned in the outermost area of the first electrode plate 210. The insulating portion 430 is adjacent to and contacts the outermost end of the separator 230, and may comprise the same material as that of the separator 230, as illustrated in the enlarged view in FIG. 6.

The electrode portion 410, may be comprise the same material as the first electrode uncoated area 215 described above. The electrode portion 410 may be thicker than the first electrode uncoated area 215 to thereby further facilitate dissipation of an electric current generated upon the penetration of a sharp object into the lithium secondary battery.

Further, the electrode portion 410 may comprise a material different from the first electrode uncoated area 215. That is, the electrode portion 410 may comprise a material having a higher electrical conductivity than the first electrode current collector 211 to further facilitate dissipation of the electric current upon the penetration of a sharp object into the battery. For this purpose, the electrode portion 410 may be thinner than the first electrode current collector 211, resulting in a reduced overall size of the electrode assembly. As a result, it is possible to achieve effective inhibition of short-circuiting of the battery as well as a further increased capacity of the lithium secondary battery by reducing the size of the electrode assembly 200.

Hereinafter, the operation of a can type secondary battery in accordance with respective embodiments will be described in more detail.

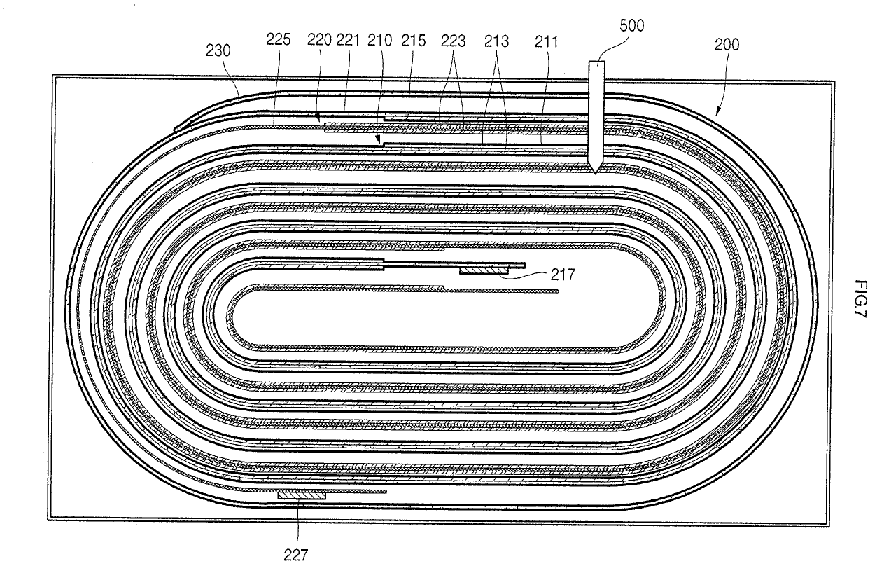

FIG. 7 is a sectional view schematically showing a nail penetration test for a lithium secondary battery.

FIG. 7 shows a nail 500 penetrated into the can 100 and into the electrode assembly 200. The nail 500 penetrates into the first electrode plate 210 and the second electrode plate 220, thus causing a short-circuit between the first electrode plate 210 and the second electrode plate 220. At the same time, the nail pin 500 penetrates into the can 100 and the first electrode plate 210, which have an opposite polarity to each other.

In the lithium secondary battery in accordance with the embodiments discussed above, the outermost turn of the first electrode plate 210 is comprised of the first electrode uncoated area 215 or the short-circuiting part 400 extending from the first electrode plate 210, and the ceramic separator 230 coated on the electrode plate. Therefore, the stability of the lithium secondary battery is significantly enhanced, due to the formation of a path through which an electric current dissipates into the can even more smoothly while preventing the propagation of internal short-circuiting upon the penetration of the nail 500 into the lithium secondary battery.

### EXAMPLES

Now, certain embodiments will be described in more detail with reference to the following Examples. These examples are provided only for illustration and should not be construed as limiting.

### Example 1 and Comparative Examples 1 to 3

A nail penetration test for a lithium secondary battery was conducted under severe conditions, e.g., a penetration rate of 5 mm/s, a 2.5 mmΦ thick nail, and a voltage of 4.31 V. The lithium secondary batteries were each subjected to the nail penetration tests 100 times. The results for occurrence of ignition (%) in the battery are given in Table 1 below.

TABLE 1

| | Comp. Ex. 1 | Comp. Ex. 2 | Comp. Ex. 3 | Ex. 1 |
|---|---|---|---|---|
| Ignition (%) | 100 | 75 | 73.3 | 0 |

Comparative Example 1 is a common secondary battery in which a typical separator was used and the outermost 1 turn of an electrode assembly was not only of an electrode uncoated area.

Comparative Example 2 is a secondary battery in which a typical separator was used and the outermost 1 turn of an electrode assembly was only an electrode uncoated area.

Comparative Example 3 is a secondary battery in which a ceramic separator was used, but the outermost 1 turn of an electrode assembly was not only of an electrode uncoated area.

Example 1 is a secondary battery in which a ceramic separator was used and the outermost 1 turn of an electrode assembly comprised only of an electrode uncoated area.

As can be seen from the results of Table 1, the common secondary battery of Comparative Example 1 exhibited 100% ignition under the above-specified conditions, e.g., severe conditions. Further, it can be seen that the frequency of ignition is still high in batteries of Comparative Examples 2 and 3 in which only the ceramic separator was used or the outermost 1 turn of an electrode assembly was only of an electrode uncoated area, even though a decrease in ignition was observed to some extent.

On the other hand, it can be seen that Example 1 exhibited no ignition of the secondary battery even under the above-specified severe conditions. That is, the stability of the lithium secondary battery upon the penetration of a sharp object into the secondary battery was significantly enhanced, due to combination of the effects obtained when the ceramic separator was applied with the effects obtained when the outermost 1 turn of an electrode assembly was formed of an electrode uncoated area.

Although the preferred embodiments have been disclosed for illustrative purposes, those skilled in the art will appreciate that various modifications, additions and substitutions are possible, without departing from the scope and spirit of the disclosure as disclosed in the accompanying claims.

What is claimed is:

1. A lithium secondary battery, comprising:
an electrode assembly comprising a first electrode plate, a second electrode plate, and a separator disposed between the first electrode plate and the second electrode plate, wound together; and
a can dimensioned and configured for receiving the electrode assembly,
wherein
the separator comprises a ceramic material,
a polarity of the first electrode plate is opposite to a polarity of the can, and
an outermost portion of the first electrode plate is disposed farther outside the electrode assembly than an outermost part of the second electrode plate.

2. The battery according to claim 1, wherein
the first electrode plate comprises an electrode current collector and an electrode active material layer,
the second electrode plate comprises an electrode current collector and an electrode active material layer,
an end of the first electrode plate comprises a first electrode uncoated area,
an end of the second electrode plate comprises a second electrode uncoated area, and
the first electrode uncoated area forms at least 1 turn disposed at the outermost portion of the first electrode plate.

3. The battery according to claim 2, wherein the first electrode uncoated area comprises only the electrode current collector.

4. The battery according to claim 2, wherein a portion of the separator surrounds the outermost portion of the electrode assembly.

5. The battery according to claim 4, wherein the portion of separator surrounding the outermost portion of the electrode assembly is adhered to a previous turn of the separator.

6. The battery according to claim 2, wherein a shortest distance from the outermost 1 turn of the first electrode uncoated area to the can has a substantially constant value around a circumference of the can.

7. The battery according to claim 6, wherein a tangent plane to the first electrode uncoated area and a tangent plane at a point of the can, joined by an imaginary line defining the shortest distance therebetween, are substantially parallel to each other.

8. The battery according to claim 1, wherein the separator comprises a porous film comprising a ceramic material and a binder.

9. The battery according to claim 1, wherein the ceramic material comprises at least one of silica (SiO₂), alumina (Al₂O₃), zirconium oxide (ZrO₂), titanium oxide (TiO₂), and any combination thereof.

10. The battery according to claim 1, wherein the separator comprises the ceramic material disposed on at least one of the first electrode plate and the second electrode plate.

11. The battery according to claim 1, further comprising a cap assembly which engages an upper part of the can and seals the can.

12. The battery according to claim 1, wherein the polarity of the first electrode plate is positive.

13. The battery according to claim 1, wherein the polarity of the first electrode plate is negative.

14. A lithium secondary battery, comprising:
an electrode assembly comprising a first electrode plate, a second electrode plate, and a separator disposed between the first electrode plate and the second electrode plate, wound together;
a short-circuiting part coupled to the electrode assembly in an outermost portion of the electrode assembly, and surrounding at least one turn of the outermost portion of the electrode assembly; and
a can dimensioned and configured for receiving the electrode assembly and the short-circuiting part,
wherein
the separator comprises a ceramic material,
a polarity of the first electrode plate is opposite to a polarity of the can,
an outermost portion of the first electrode plate is disposed farther outside the electrode assembly than an outermost portion of the second electrode plate, and
the short-circuiting part comprises an insulating portion adjacent to and contacting the outermost end of the separator and an electrode portion coupled to the outermost end of the first electrode plate.

15. The battery according to claim 14, wherein
the first electrode plate comprises an electrode current collector and an electrode active material layer,
an end of the first electrode plate comprises an electrode uncoated area, and
the insulating portion surrounds an outermost portion of the electrode assembly.

16. The battery according to claim 15, wherein the electrode portion and the current collector of the first electrode plate comprise a same material.

17. The battery according to claim 16, wherein the electrode portion is thicker than the current collector of the first electrode plate.

18. The battery according to claim 15, wherein the electrode portion and the current collector of the first electrode plate comprise a same material having a high electrical conductivity.

19. The battery according to claim 18, wherein the electrode portion is thinner than the current collector of the first electrode plate.

20. The battery according to claim 14, wherein the separator comprises a porous film comprising a ceramic material and a binder.

21. The battery according to claim 14, wherein the ceramic material comprises at least one of silica (SiO₂), alumina (Al₂O₃), zirconium oxide (ZrO₂), titanium oxide (TiO₂), and any combination thereof.

22. The battery according to claim 14, wherein the separator comprises a ceramic material disposed on at least one of the first electrode plate or the second electrode plate.

23. The battery according to claim 14, wherein at least a portion of the separator is disposed on the electrode portion.
